(19) United States
(12) Patent Application Publication
(10) Pub. No.: US 2002/0039141 A1
(43) Pub. Date: Apr. 4, 2002

(54) Image sensing apparatus usable in combination with printer and control method therefor

(76) Inventors: Koichi Washisu, Tokyo (JP); Futoshi Hirai, Kanagawa (JP)

Correspondence Address: MORGAN & FINNEGAN, L.L.P., 345 PARK AVENUE, NEW YORK, NY, 10154, US

(21) Appl. No.: 09/951,297

(22) Filed: Sep. 11, 2001

(30) Foreign Application Priority Data
Sep. 11, 2000 (JP) 275299/2000
Sep. 12, 2000 (JP) 276724/2000

(51) Int. Cl. H04N 5/225

(52) U.S. Cl. 348/232; 348/207

(57) ABSTRACT

A camera with a printer for printing an image sensed by an image sensing optical element stores the sensed image data and its printing log in relation with the image data. In managing each image data, whether or not image data is printed image data is identified on the basis of the stored printing log. Management is performed in accordance with this identification result.

### FIELD OF THE INVENTION

The present invention relates to an image sensing apparatus usable in combination with a printer and a control method therefor and, more particularly, to image printing control, image information erase control, and image information browsing control in an image sensing apparatus usable in combination with a printer.

### BACKGROUND OF THE INVENTION

As apparatuses and systems for viewing photographed images on the spot, apparatuses in U.S. Pat. Nos. 3,709,122, 3,727,529, 4,000,500, 4,249,811, and 4,212,524, and a system for allowing viewing photographed images a short period of time after the photography using a so-called instant camera and instant film in U.S. Pat. No. 3,707,116 are disclosed.

The conventional apparatuses and systems have the following drawbacks. 1) Since a photographed image is recorded on an instant film, if a plurality of prints of a photographed image are required, the instant film on which the photographed image is recorded must be copied using another apparatus. Further, it is inconvenient to keep the instant film on which the photographed images are recorded, as compared with a silver halide film. 2) Even if all the photographed images need not be always recorded on an instant film on the spot, the images which need not be recorded on the instant film can not be erased afterwards.

As a means for compensating for the drawbacks of the conventional apparatuses and systems described above, a camera with a printer can be considered in which images photographed by an electronic image sensing means such as a solid-state image sensing element are stored in a memory as image data, and arbitrary image data stored in the memory is printed with the built-in printer.

Examples of a printer capable of printing image data are generally a fusing type thermal transfer printer, sublimation type thermal transfer printer, and inkjet printer. Among them all, an inkjet printer is very effective for use as a printer for a camera because it is excellent in running cost, compactness, energy consumption, and output speed.

As examples of the above-mentioned camera with a printer, a camera with a printer for converting an image into image data by a solid-state image sensing element or the like and printing the image on the basis of the converted image data is disclosed in U.S. Pat. No. 4,074,324 and Japanese Patent Laid-Open No. 54-136325. Another conventional camera with a printer capable of printing images on several types of printing sheets using several types of ink ribbons is disclosed in Japanese Patent Laid-Open No. 4-200181.

Each conventional camera with a printer described above is a user-oriented model in which a camera is formed integrally with a printer. However, printing log information of image data is not offered to users. A user may print the same image data again, or may mistakenly print undesired image data instead of desired image data. Selection error tends to occur in selecting desired image data to be printed from stored image data.

The camera with a printer described above is a composite device in a new genre in which a camera is formed integrally with a printer. The camera with a printer is a premature consumer product. For example, image information stored in a memory incorporated in a camera with a printer may be erroneously erased. It is very cumbersome and time-consuming to search for an unprinted image from a large number of stored image information and print it or to search for a favorite printed image from a large number of stored image information and browse it. It is also very cumbersome and time-consuming to select printed and unprinted image information from a large number of stored image information for making a free space in a memory by discriminating printed information from unprinted information and erasing the printed information. SUMMARY OF THE INVENTION

The present invention has been made in consideration of the above situation, and has as its first object to provide an image sensing apparatus usable in combination with a printer and a control method therefor, which can improve operability to reduce image data selection error in selecting desired image data, such as image data to be printed, from the stored image data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic perspective view of a camera with a printer according to a first embodiment of the present invention;

FIG. 2 is a block diagram showing the schematic arrangement of the camera with a printer shown in FIG. 1;

FIG. 3 is a view showing a display example on the monitor of the camera with a printer according to the first embodiment of the present invention;

FIG. 4 is a flow chart showing printing identification character string display processing according to the first embodiment of the present invention;

FIG. 5 is a flow chart showing printed image data display processing according to the first embodiment of the present invention;

FIG. 6 is a block diagram showing the schematic arrangement of a camera with a printer according to a second embodiment of the present invention;

FIG. 7 is a view showing index display of a plurality of image data on the monitor of the camera with a printer according to the second embodiment of the present invention;

FIG. 8 is a flow chart of image data printing processing executed by a camera microcomputer according to the second embodiment of the present invention;

FIG. 9 is a perspective view of a camera with a printer according to a third embodiment of the present invention when viewed from the front;

FIG. 10 is a perspective view of the camera with a printer shown in FIG. 9 when viewed from the back;

FIG. 11 is a block diagram showing the functional arrangement of the camera with a printer shown in FIG. 9;

FIG. 12 is a flow chart showing the operation sequence in an image erase mode according to the third embodiment of the present invention;

FIG. 13 is a flow chart showing the operation sequence in a printed image erase mode according to a fourth embodiment of the present invention;

FIGS. 14A and 14B are views illustrating erasure of image data in a printed image simultaneous erase mode according to the fourth embodiment of the present invention;

FIG. 15 is a flow chart showing the operation sequence in an unprinted image erase mode according to a fifth embodiment of the present invention;

FIG. 16 is a view illustrating image data erasure in an unprinted image simultaneous erase mode according to the fifth embodiment of the present invention;

FIG. 17 is a flow chart showing the operation sequence in an image display mode according to a sixth embodiment of the present invention;

FIG. 18 is a view showing a display example of printed images in a printed image display mode according to the sixth embodiment of the present invention;

FIG. 19 is a view showing a display example of printed images in a printed image list display mode according to the sixth embodiment of the present invention;

FIG. 20 is a flow chart showing the operation sequence in an unprinted image display mode according to a seventh embodiment of the present invention;

FIG. 21 is a view showing a display example of unprinted images in an unprinted image display mode according to the seventh embodiment of the present invention; and

FIG. 22 is a view showing a display example of unprinted images in an unprinted image list display mode according to the seventh embodiment of the present invention.

### DETAILED DESCRIPTION OF THE PREFERRED EMBODIMENTS

Preferred embodiments of the present invention will now be described in detail in accordance with the accompanying drawings.

<First Embodiment>

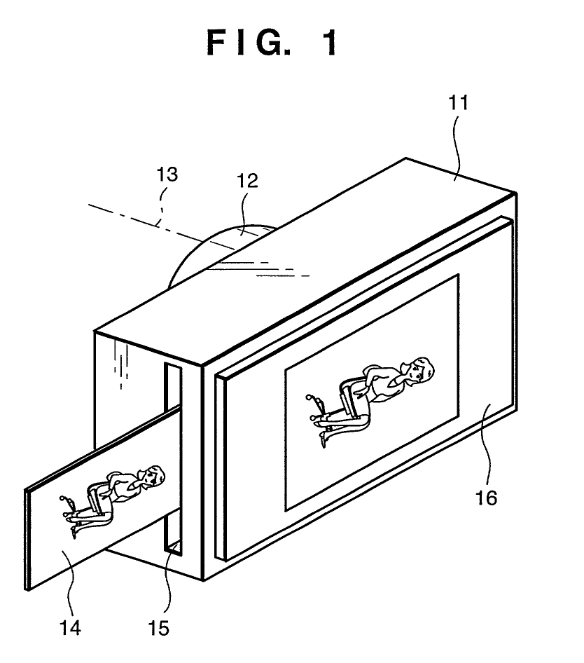

FIG. 1 is a schematic perspective view of a camera with a printer according to the first embodiment of the present invention.

Referring to FIG. 1, a camera 11 with a printer is comprised of a photographic lens barrel 12 on the front surface of the camera body, an opening 15 in a side surface of the camera body, a monitor 16 on the back surface of the camera body, an inkjet printer arranged inside the back surface of the camera body, and a memory 22 (to be described later) and image sensing element (not shown) which are arranged inside the camera body.

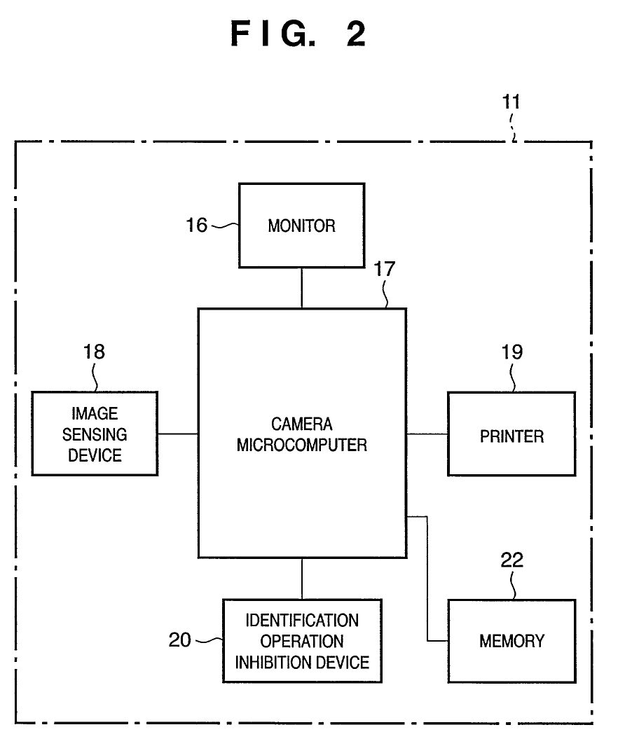

FIG. 2 is a block diagram showing the schematic arrangement of the camera 11 with a printer shown in FIG. 1.

Referring to FIG. 2, the camera 11 with a printer is comprised of a monitor 16 for displaying an image of an object to be photographed or image data (photographed images) of an image file stored in a memory 22, an image sensing device 18 for capturing an object image to be photographed, a printer 19 for printing image data, an identification operation inhibition device 20 for outputting a command for inhibiting display of a printing identification character string 21 (identification result) displayed on the monitor 16, a memory 22 for storing image files (to be described later), and a camera microcomputer 17 connected to the monitor 16, image sensing device 18, printer 19, identification operation inhibition device 20, and memory 22. The printer 19 includes an ink tank (not shown), a carriage (not shown), and a motor (not shown) for driving the carriage.

When the camera 11 with a printer photographs an object, an object image enters through the photographic lens barrel 12 and is formed on the image sensing element. The camera microcomputer 17 writes the formed object image as image data in an image file. This image file is stored in the memory 22. When image data printing processing is started in response to user's printing designation operation, a printing sheet 14 on which the image data is printed is discharged from the opening 15 along with the progress of printing.

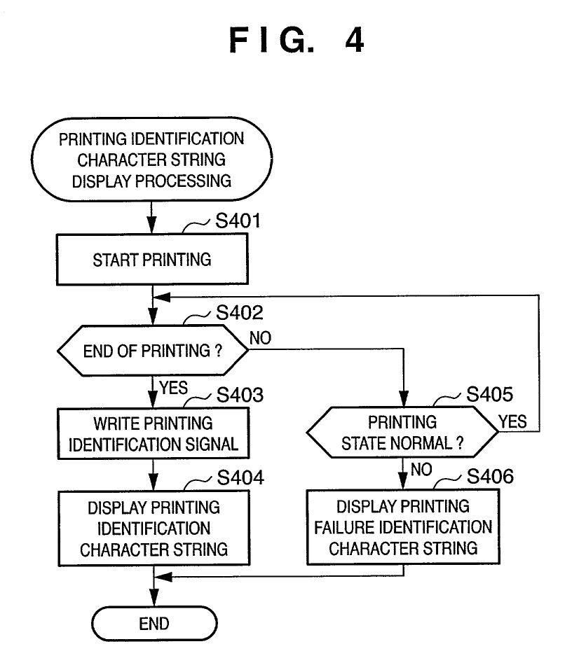

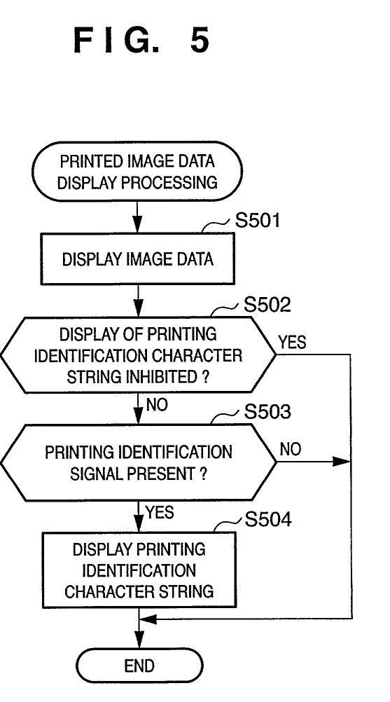

The camera microcomputer 17 causes the printer 19 to print image data displayed on the monitor 16 on the basis of user's printing designation operation. At the same time, the camera microcomputer 17 executes printing character string display processing (FIG. 4) and printed image data display processing (FIG. 5), both of which will be described later.

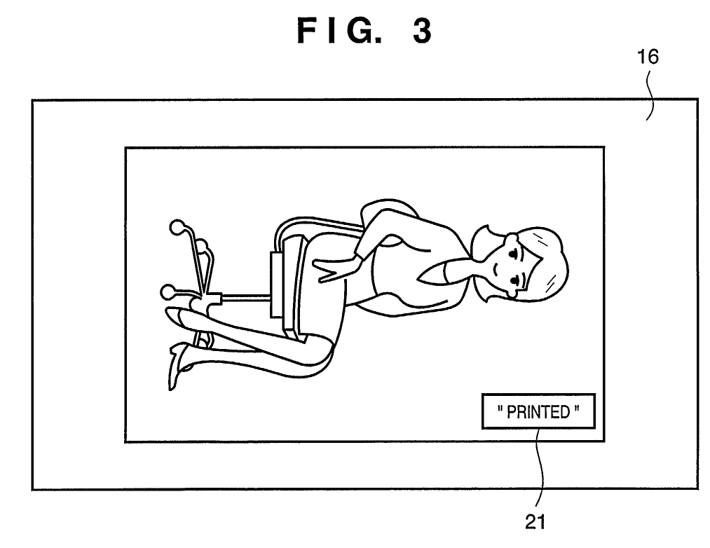

FIG. 3 is a view for explaining full screen display of image data on the monitor 16 of the camera 11 with a printer.

When image data printing is complete, a printing identification character string 21 representing that the image has been printed is displayed at the lower right position of the image data full screen-displayed on the monitor 16 shown in FIG. 3.

Printing identification character string display processing and printed image data display processing to be executed by the camera microcomputer 17 in FIG. 2 will be described with reference to the accompanying drawings.

FIG. 4 is a flow chart of printing identification character string display processing executed by the camera microcomputer 17 in FIG. 2.

Image data printing is started in response to user's printing designation operation (step S401). It is then determined whether image data printing is complete (step S402).

When image data printing is complete as a result of determination in step S402, a printing identification signal (printing log) representing that printing has already been made is written in an image file in which the image data is written (step S403). The printing identification character string 21 is displayed at, e.g., the lower right position of the image data full screen-displayed on the monitor 16 (step S404). This processing is then ended.

As a result of determination in step S402, when it is determined that image data printing is not complete, it is determined on the basis of the remaining ink amount of an ink tank in the printer 19 or the driving load of a motor in the printer 19 whether an image data printing state is normal (step S405).

As a result of determination in step S405, when the image data printing state is normal, processing from step S402 is repeated; otherwise, a printing failure identification character string (identification result) such as “printing failure” representing that the image data printing state is not normal is displayed at, e.g., the right lower position of the image data full screen-displayed on the monitor 16 (step S406). This processing is then ended.

According to processing in FIG. 4, when image data printing is normally complete (YES in step S402), the printing identification character string 21 is displayed at the lower right position of the image data full screen-displayed on the monitor 16 (step S404). The user can know that image data need not be printed again. When image data printing is not normally complete (NO in step S402), the printing failure identification character string is displayed at the lower right position of the image data full screen-displayed on the monitor 16 (step S406). The user can know that the image data needs be printed again.

FIG. 5 is a flow chart showing printed image data display processing executed by the camera microcomputer 17 in FIG. 2.

The image data of an image file selected from the memory 22 on the basis of user's display designation operation is displayed on the monitor 16 (step S501). It is determined whether the identification operation inhibition device 20 outputs a command for inhibiting display of the printing identification character string 21 in response to a display inhibition command for the printing identification character string 21 from the user (step S502).

As a result of determination in step S502, when the identification operation inhibition device 20 outputs a command for inhibiting display, this processing is immediately ended. When the identification operation inhibition device 20 does not output a command for inhibiting display, it is determined whether a printing identification signal is written in the selected image file (step S503).

As a result of determination in step S503, when no printing identification signal is written in the selected file, this processing is immediately ended; otherwise, the printing identification character string 21 is displayed at the lower right position of the image data full screen-displayed on the monitor 16 (step S504), thereby notifying the user that the image data of the selected image file has already been printed. This processing is then ended.

According to processing in FIG. 5, the camera microcomputer 17 identifies on the basis of the printing identification signal of the selected image file whether the image data of this image file has already been printed (step S503) and, if printed, controls to display the printing identification character string 21 at, e.g., the lower right position of the image data full screen-displayed on the monitor 16 (step S504). This can prevent the user from printing the same data again or printing another image data in place of the desired image data. In addition, when the user wants to print the same data as the printed image data, he can readily identify this image data.

The camera microcomputer 17 inhibits displaying the printing identification character string 21 on the basis of the command from the identification operation inhibition device 20 which corresponds to the display inhibition designation for the printing identification character string 21 from the user (YES in step S502). When the user does not want display of the printing identification character string 21, he can inhibit display of the printing identification character string 21. If the user wants to display the printing identification character string 21, he can cancel inhibition for displaying the printing identification character string 21.

In the processing operations of FIGS. 4 and 5, when an image data printing state is not normal, the camera microcomputer 17 writes the printing failure identification signal (printing log) in the image file in which this image data is written. When the image data of this image file is to be displayed on the monitor 16, the printing failure identification character string may be displayed at the lower right position of the image data full screen-displayed on the monitor 16 on the basis of the printing failure identification signal. When the user is to print image data whose printing is not normally complete, another image data will not be mistakenly printed in place of the desired image data.

<Second Embodiment>

A camera with a printer according to the second embodiment of the present invention will be described below.

The schematic arrangement of the camera with a printer according to the second embodiment is basically the same as that of the camera with a printer according to the first embodiment and is partially different from it.

The camera with a printer according to the second embodiment will be described with reference to the accompanying drawings.

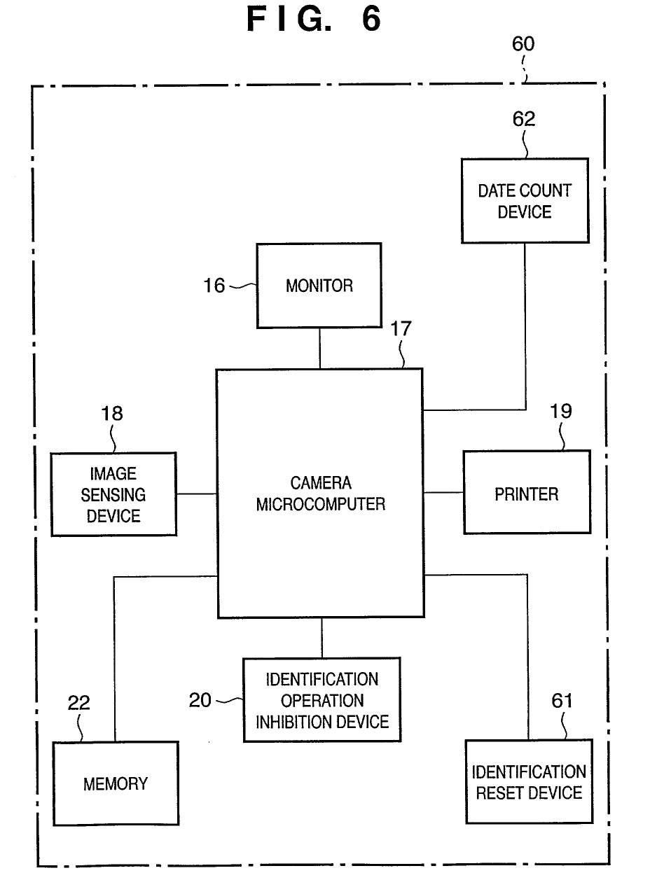

FIG. 6 is a block diagram showing the schematic arrangement of the camera with a printer according to the second embodiment.

Referring to FIG. 6, a camera 60 with a printer is basically the same as the camera 11 with a printer except that an identification reset device 61 and date count device 62 are additionally connected to a camera microcomputer 17. The same reference numerals as in FIG. 2 denote the same parts in FIG. 6, and a detailed description thereof will be omitted.

When a user designates reset operation, the identification reset device 61 not only outputs a command for stopping displaying a printing identification frame 70 (identification result) (to be described later) which surrounds each image data displayed on a monitor 16, a cumulative printing count 71 of each image data, and a latest printing date 72 (to be described later) of each image data, but also resets to initial states a printing identification signal, printing failure identification signal, cumulative printing count data, and latest printing date data of each image file in which each image data is written. When image data is printed again, a printing identification signal is written in the corresponding image file, and the cumulative printing count data (initial value is 0) of this image file is incremented by one. At the same time, the latest printing date data of this image file is updated to the date read by the date count device 62.

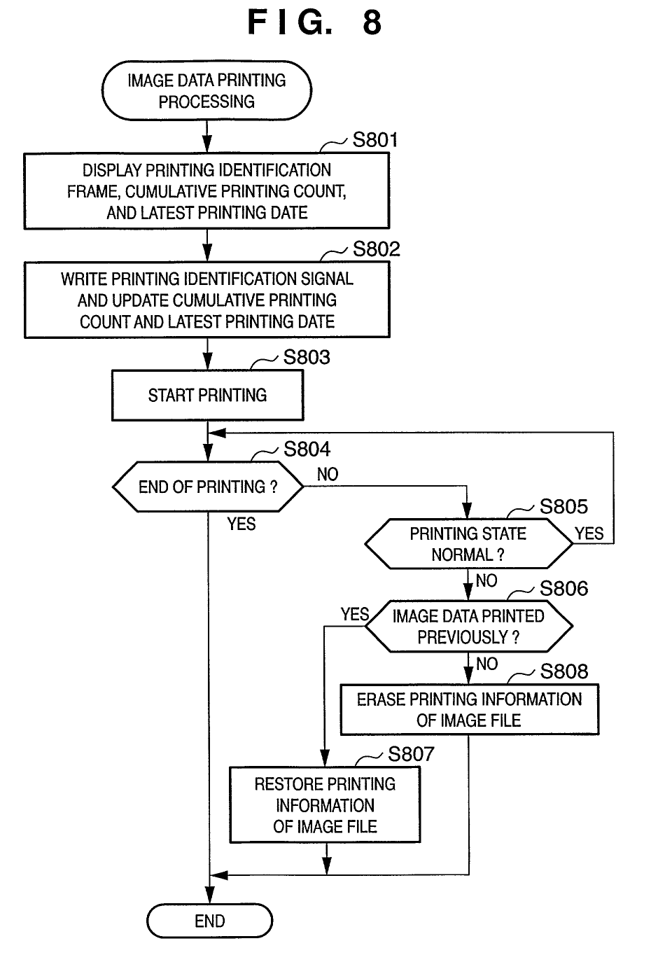

The camera microcomputer 17 performs image data printing processing in FIG. 8 (to be described later).

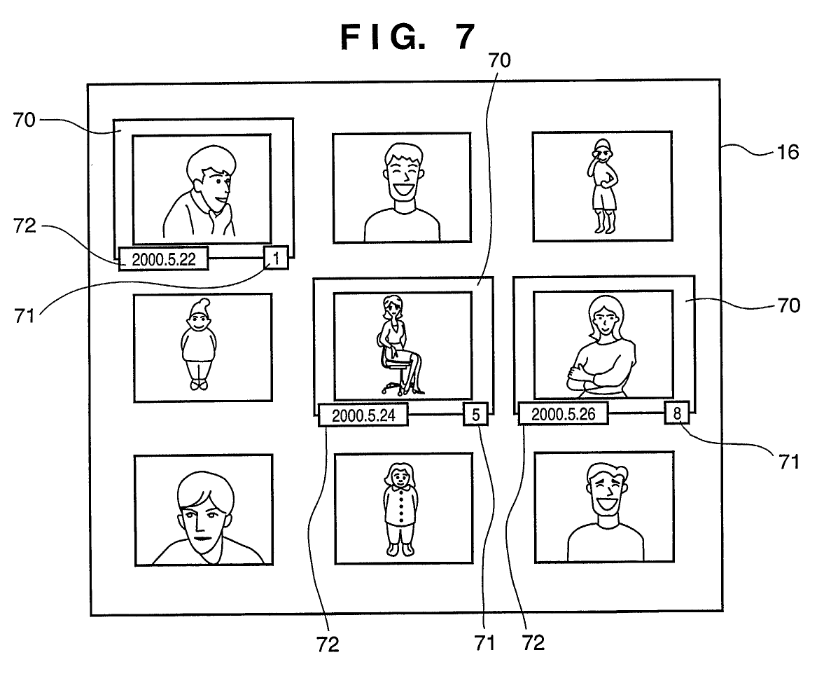

FIG. 7 is a view for explaining index display of a plurality of image data on the monitor 16 of the camera 60 with a printer according to the second embodiment.

Referring to FIG. 7, a plurality of image data having been photographed so far are displayed on the monitor 16. Of the plurality of image data, each printed image data is attached with the printing identification frame 70 representing that the image data has been already printed, the cumulative printing count 71 representing the number of times the corresponding image data is printed, and the latest printing date 72 representing the latest date at which the corresponding image data was printed.

Image data printing processing to be executed by the camera microcomputer 17 will be described with reference to FIG. 8.

FIG. 8 is a flow chart of image data printing processing executed by the camera microcomputer 17 according to the second embodiment.

This processing is executed when desired image data displayed on the monitor 16 is selected and printed or when image data displayed on the monitor 16 immediately upon photography is to be printed.

This processing is started in response to user's printing designation operation (printing command). A print count obtained by adding a printing count desired by the user to the cumulative printing count of the image file in which data to be printed is written is attached to the image data and displayed as the cumulative printing count 71 on the monitor 16. At the same time, a printing designation operation date read by the date count device 62 is attached to the image data and displayed as the latest printing date 72. The printing identification frame 70 is also attached to the image data (step S801).

In step S802, the cumulative printing count data of the image file is updated to the attached and displayed cumulative printing count 71. The latest printing date data of the image file is updated to the attached and displayed latest printing date 72. A printing identification signal is written in the image file.

In step S803, printing of the image data is started, and then it is determined whether the image data printing is complete (step S804).

As a result of determination in step S804, when printing is complete, this processing is ended; otherwise, it is determined on the basis of the remaining ink amount of an ink tank in the printer 19 or the driving load of a motor in the printer 19 whether an image data printing state is normal (step S805).

As a result of determination in step S805, when the image data printing state is normal, the flow returns to step S804; otherwise, the camera microcomputer 17 stops displaying the cumulative printing count 71, latest printing date 72, and the printing identification frame 70 attached to the image data and displayed together with the image data. A printing failure identification character string is attached to and displayed together with the image data on the monitor 16. It is determined whether the image data has been printed before the current processing (step S806).

As a result of determination in step S806, when the image data has been printed previously, the printing identification signal, cumulative printing count data, and latest printing date data (these will be referred to as “printing information” hereinafter) of the image file are returned to the states before updating of step S802 (step S807). When the image data is not printed previously, the printing information of the image file is erased (step S808), and this processing is ended.

According to the second embodiment, the camera microcomputer 17 so controls as to attach the printing identification frame 70 and cumulative printing count 71 to the image data and display them together with the image data (step S801). The user can know the remaining number of prints of image data to be printed and whether or not any print is forgotten to be distributed in accordance with the remaining number of prints. In addition, the camera microcomputer 17 so controls as to attach the latest printing date 72 to the image data and display it together with the image data (step S801). The user may be able to remember the storage location of prints of photographed images and the distribution destinations to which the prints have already been distributed.

The camera microcomputer 17 can reset the printing information on the basis of a command from the identification reset device 61 not to display the printing identification frame 70, cumulative printing count 71, and latest printing date 72 attached to the image data and displayed together with it. When the user uses old image data again, the number of prints of this image data can be determined without being confused with the old printing log.

Note that the monitor 16 of the camera 60 with a printer may full screen-display only one image data. In this case, the printing identification character string 21 is attached to and displayed at, e.g., the lower right position of the image data full screen-displayed on the monitor 16. The cumulative printing count 71 and latest printing date 72 are attached to and displayed together with the image data.

The user may select desired image data and print the selected image data while the plurality of image data shown in FIG. 7 are index-displayed. In this case, the printing identification frame 70, cumulative printing count 71, and latest printing date 72 are attached to and displayed together with the selected image data upon printing operation for the selected image data is designated.

The display positions of the printing identification character string 21, cumulative printing count 71, and latest printing date 72 are not limited to these shown in FIGS. 3 and 7. These data may be displayed at arbitrary positions if these positions do not interfere with image data viewing.

The second embodiment as described above can prevent the user from printing the same data again or printing another image data in place of the desired image data. In addition, when the user wants to print the image data which has been printed before, he can readily identify this image data. As a result, when the user selects desired image data from the stored image data, selection error of image data may be reduced.

<Third Embodiment>

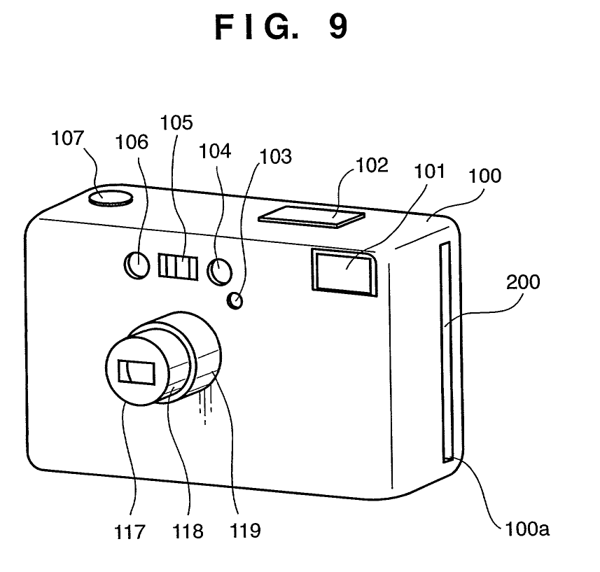

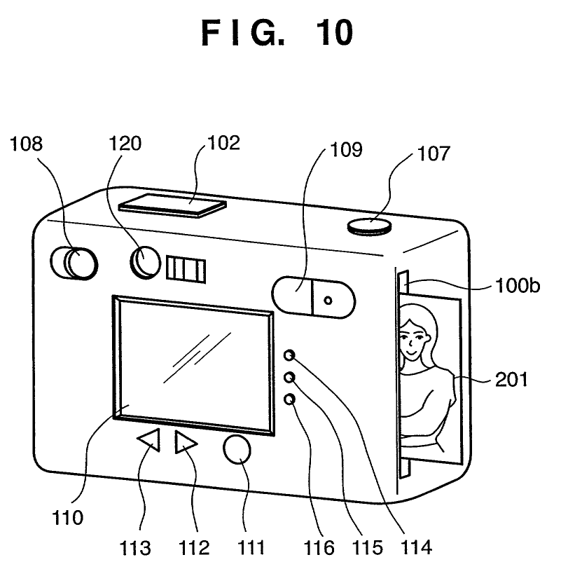

FIG. 9 is a perspective view of the camera with a printer according to the third embodiment of the present invention when viewed from the front. FIG. 10 is a perspective view showing the camera with a printer in FIG. 9 when viewed from the back.

The camera with a printer of the third embodiment comprises a digital camera unit for storing an image sensed with an image sensing element such as a CCD in a memory and a printer unit for printing the image, stored in the memory, on a printing sheet by an inkjet printing scheme and outputting the printed sheet.

More specifically, as shown in FIG. 9, a lens barrel (one-group lens barrel 118 and cam cylinder 119) having a photographic lens unit 117 is mounted on the front surface of a camera body 100 of the camera with a printer. A photometric AE window 103, AF light projection window 104, AF light-receiving window, finder objective window 105, and electronic flash 101 are formed on the front surface of the camera body 100. An information liquid crystal display panel 102 and release button 107 are formed on the upper surface of the camera body 100. An insertion port 100a for receiving a cartridge 200 is formed in the right side surface (when viewed from the front) of the camera body 100. The cartridge 200 feedably stores a plurality of print sheets.

As shown in FIG. 10, a main switch 108, zoom button 109, image liquid crystal display panel 110, print button 111, next-image button 112, previous-image button 113, mode selection button 114, photography/printing selection button 115, image erase button 116, and finder eyepiece 120 are formed on the rear surface side of the camera body 100. A print sheet discharge port 100b for discharging the print sheet 201 on which an image is printed is formed in the left side surface (when viewed from the front) of the camera body 100. FIG. 10 shows a state in which an image is printed on the print sheet 201 fed from the cartridge 200 loaded in the camera body 100, and this print sheet 201 is being discharged from the print sheet discharge port 100b.

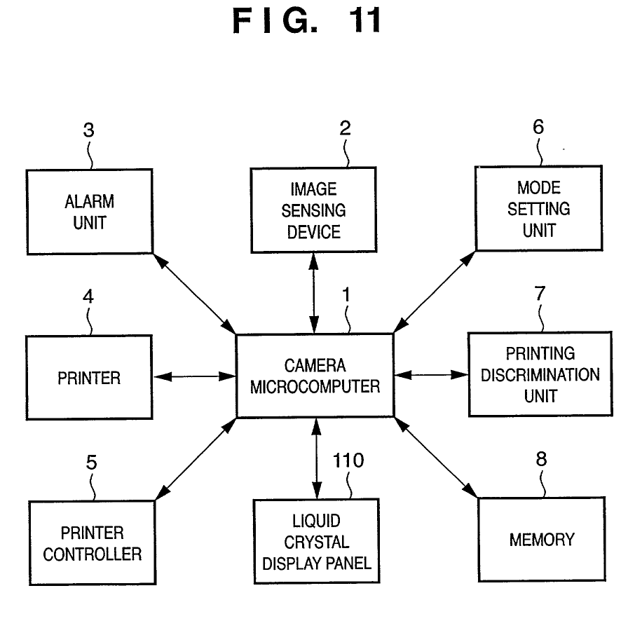

The functional arrangement of the camera with a printer will be described with reference to FIG. 11. FIG. 11 is a block diagram showing the functional arrangement of the camera with a printer shown in FIG. 9.

As shown in FIG. 11, the camera with a printer comprises a camera microcomputer 1 for controlling the overall apparatus, an image sensing device 2 for sensing an object image and outputting it as an image signal, an alarm unit 3 for generating an alarm when image data is erased, a printer 4 for printing image data on a print sheet fed from the cartridge 200, a printer controller 5 for controlling the printing operation of the printer 4, a mode setting unit 6 for setting a photographic mode, image quality mode, print output mode, or the like, a printing discrimination unit 7 for discriminating printed image data from unprinted image data, a memory 8 for storing image data, and the image liquid crystal display panel 110 for displaying image data. These functional blocks will be described in detail later.

The operation of the camera with a printer according to the third embodiment will be described with reference to FIGS. 9 to 11.

When the main switch 108 is turned on, the camera with a printer is powered on. The power to the camera is supplied from a camera body battery (not shown). Upon turning on the main switch 108, the camera microcomputer 1 drives the image sensing device 2. More specifically, the lens barrel 118 and cam cylinder 119 are driven to extend and set the lens assembly to the photographic position.

The user sets an image quality mode using the mode setting unit 6. The camera with a printer of the third embodiment has a few image data compression modes such as a high image quality (low compression rate) mode, a normal image quality (middle compression rate) mode, and a low image quality (high compression rate) mode. The image quality mode can be selected using the mode selection button 114 in practice. A signal representing an image quality mode selected upon operating the mode selection button 114 is input to the camera microcomputer 1. The selected image quality mode is then set.

The user then adjusts the field angle using the zoom button 109 for photography. When the user presses the release button 107 to the first stroke (e.g., half-stroke state), the camera microcomputer 1 determines various conditions required for exposure operation such as the exposure control value corresponding to an amount of light incident through the AE window 103, distance measurement information using infrared rays projected through the AF light projection window 104 and received by the AF light-receiving window 106, and the presence/absence of light emission of the electronic flash 101. To actually photograph an object, the user further presses the release button 107 (e.g., full-stroke state), the camera microcomputer 1 performs a series of exposure operations such as lens driving for focusing, shutter speed control, aperture ratio control, and if necessary, flash emission.

By such exposure operation, an optical object image passing through the photographic lens unit 117 is converted into image data of an electrical signal by a photoelectric conversion element 308. The image data is converted into a digital signal by an A/D converter (not shown). The image data upon photography has a large data amount and is then compressed to reduce the data amount. The compressed image data is received by and stored in the memory 8.

Upon exposure operation, the camera microcomputer 1 displays the photographed image data by driving the display panel 110. The photographic operation is performed by repeating operations described above. The photographed image data are sequentially stored in the memory 8.

When the user wants a print of the photographed image data, the user sets a print output mode using the mode setting unit 6. More specifically, the user uses the photography/printing selection button 115. In this embodiment, the camera has the dedicated button, but the present invention is not limited to this. For example, a setting method of using a button displayed on the display panel 110 may be employed. The user searches desired image data stored in the memory 8 using the next-image button 112 and previous-image button 113 while images being displayed on the display panel 110, and selects image data to be printed. The user then presses the print button 111 to set the camera microcomputer 1 to the printing operation. In executing the printing operation, the printer controller 5 outputs the image data stored in the memory 8 from the printer 4.

To allow the user to erase image data stored in the memory 8, the user operates the next-image button 112 and previous-image button 113 to display image data to be erased on the display panel 110. The user then operates the image erase button 116 to erase the displayed image data. To erase image data, an erase confirmation alarm is preferably displayed on the display panel 110.

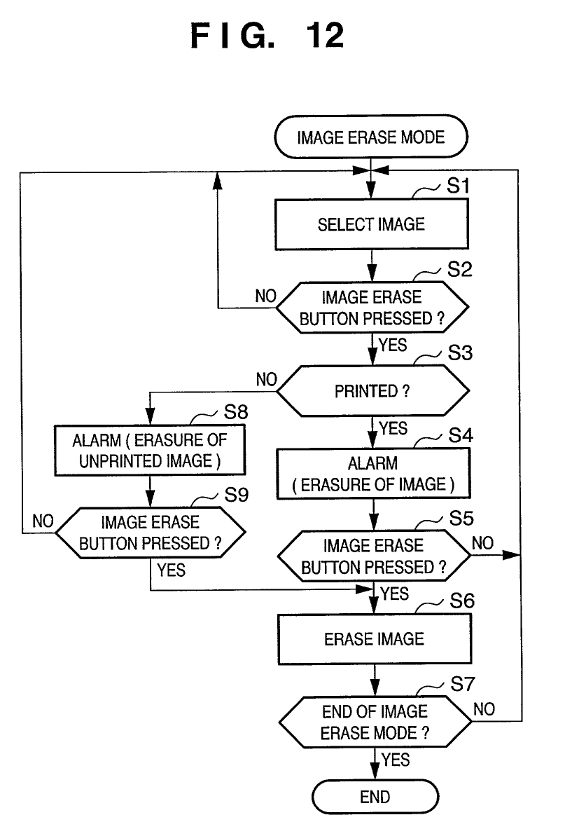

The operation in the image erase mode according to the third embodiment of the present invention will be described with reference to FIG. 12. FIG. 12 is a flow chart showing the operation sequence in the image erase mode of the camera with a printer shown in FIG. 9. This image erase mode is executed by the camera microcomputer 1 in accordance with a program stored in a ROM (not shown).

When the image erase mode is set with the mode setting unit 6, in step S1 the user instructs to display image data by operating the next-image button 112 and previous-image button 113, and selects image data to be erased. The flow advances to step S2 to determine whether the image erase button 116 is operated. If NO in step S2, the flow returns to step s1.

If YES in step S2, the flow advances to step S3 to determine on the basis of the discrimination result of the printing discrimination unit 7 whether the selected image data is the printed image data. If YES in step S3, the flow advances to step S4 to alarm erasure of the printed data by the alarm unit 3. More specifically, an alarm for erasure of image data is displayed on the display panel 110. This alarm may be displayed as a phrase, such as “image erasure OK?”, or may be displayed with any symbol. In this embodiment, the alarm is displayed on the liquid crystal display panel 110. However, a sound alarm may be used.

The flow then advances to step S5 to determine whether the image erase button 116 is operated again. If NO in step S5 (e.g., another button is operated), the flow returns to step S1. When it is determined that the image erase button 116 is operated, the flow advances to step S6 to erase the selected image data. The flow then advances to step S7 to determine whether the image erase mode is ended. If NO in step S7, the flow returns to step S1; otherwise, this processing is ended.

When it is determined in step S3 that the selected image data is not the printed data, i.e., unprinted image data, the flow advances to step S8 to display an alarm for erasure of the unprinted image data on the image liquid crystal display panel 110. This alarm is preferably displayed in a phrase, such as “Unprinted image! Erasure OK?”, so as to emphasize the alarm as compared with the alarm displayed in erasing the printed image data. The alarm for erasure of the unprinted image data may be displayed using any symbol. In this embodiment, the alarm for erasure of the unprinted image data is displayed on the display panel 110, but a sound alarm may be used. In this case, this alarm must be more emphasized than the sound alarm used in erasing the printed image data.

The flow then advances to step S9 to determine again whether the image erase button 116 is operated. If NO in step S9 (any other button is operated), the flow returns to step S1. However, if YES in step S9, the flow advances to step S6 to erase the selected image data. The flow advances to step S7 to determine whether the image erase mode is ended. If NO in step S7, the flow returns to step S1; otherwise, this processing is ended.

In erasing image data from the stored image data, when unprinted image data is selected as image data to be erased, an alarm more emphasized than the alarm in erasing the printed image data is generated, thereby reducing erroneous erasure of the unprinted image data. In addition, erase error of erasing image data other than desired image data can be prevented, and the desired image data can be erased.

<Fourth Embodiment>

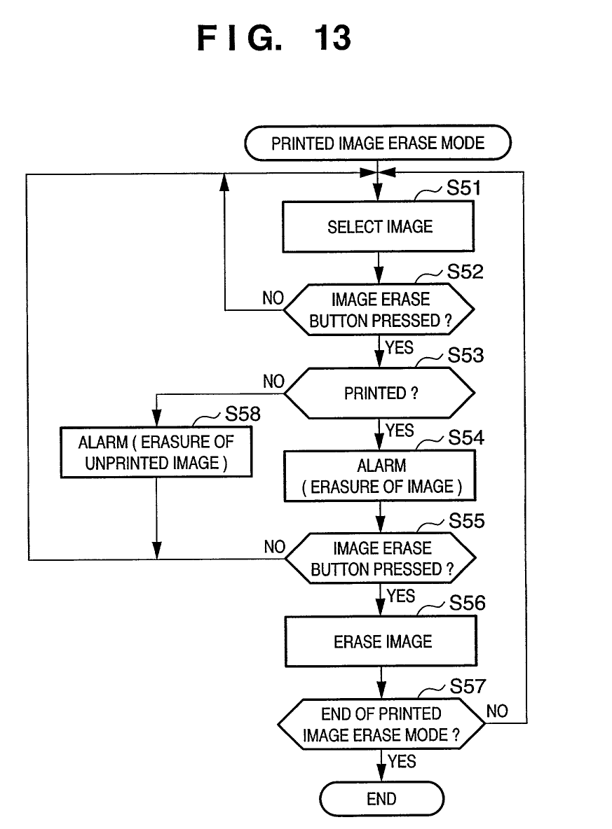

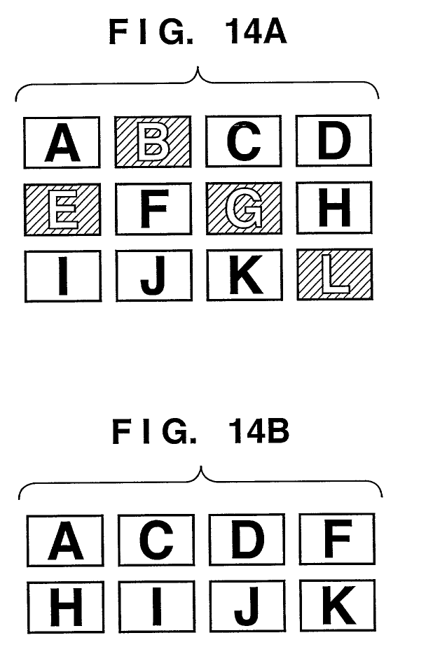

The fourth embodiment of the present invention will be described with reference to FIGS. 13, 14A, and 14B. FIG. 13 is a flow chart showing the operation sequence in a printed image erase mode of a camera with a printer according to the fourth embodiment of the present invention. FIGS. 14A and 14B are views illustrating image data erasure in a printed image simultaneous erase mode of the camera with a printer according to the fourth embodiment of the present invention. Note that since the camera with a printer of this embodiment has the same arrangement as that described with reference to the third embodiment, a detailed description of the arrangement will be omitted. The same reference numerals as in the third embodiment denote the same parts in the fourth embodiment.

In the fourth embodiment, the camera with a printer has a printed image erase mode for erasing printed image data. The fourth embodiment further has a printed image simultaneous erase mode for simultaneously selecting and erasing printed image data.

When the user sets the printed image erase mode with a mode setting unit 6, the user operates a next-image button 112 and previous-image button 113 to select image data to be erased while displaying the image data on a display panel 110 in step S51 as shown in FIG. 13. The flow advances to step S52 to determine whether an image erase button 116 is operated. If NO in step S52 (any other button is operated), the flow returns to step S51.

If YES in step S52, the flow advances to step S53 to determine on the basis of the discrimination result of a printing discrimination unit 7 whether the selected image data is printed image data. If YES in step S53, the flow advances to step S54 to alarm erasure of the selected image data by an alarm unit 3. More specifically, an alarm for erasure of image data is displayed on the display panel 110. This alarm may be displayed as a phrase, such as “image erasure OK?”, or may be displayed with any symbol. In the fourth embodiment, the alarm is displayed on the display panel 110. However, a sound alarm may be used.

The flow then advances to step S55 to determine whether the image erase button 116 is operated again. If NO in step S55 (e.g., another button is operated), the flow returns to step S51. When it is determined that the image erase button 116 is operated, the flow advances to step S56 to erase the selected image data. The flow then advances to step S57 to determine whether the printed image erase mode is ended. If NO in step S57, the flow returns to step S51; otherwise, this processing is ended.

When it is determined in step S53 that the selected image data is unprinted image data, the flow advances to step S58 to alarm that the selected image is the unprinted image data by the alarm unit 3. More specifically, this alarm is displayed on the display panel 110. This alarm may be displayed in a phrase, such as “Unprinted image!!”, or using any symbol. A sound alarm may be used. The flow then returns to step S51.

The camera with a printer in the fourth embodiment can be set to the printed image simultaneous erase mode for simultaneously erasing printed image data out of the image data stored in a memory 8.

An erasure operation in the printed image simultaneous erase mode will be described with reference to FIGS. 14A and 14B.

For example, as shown in FIG. 14A, assume that 12 image data A to L (the number of image data may be arbitrary) are stored in the memory 8. Image data represented by black letters are defined as unprinted image data, and image data represented by hollow letters are defined as printed image data. When the user sets the printed image simultaneous erase mode with the mode setting unit 6 and operates the image erase button 116, a camera microcomputer 1 alarms by the alarm unit 3 that all the printed image data will be erased. More specifically, an alarm for erasing all the printed image data is displayed on the display panel 110. This alarm may be, in a phrase, e.g., “All the printed image data will be erased OK?”, or by any symbol. Alternatively, a sound may be used instead of displaying the alarm on the display panel 110.

After the alarm for erasure of all the printed image data, when the image erase button 116 is operated again, all the printed image data are erased, and only unprinted image data are left in the memory 8, as shown in FIG. 14B.

As described above, according to the fourth embodiment, only the printed image data can be selectively erased. Further, it is possible to simultaneously select and erase all the printed image data.

According to the fourth embodiment, erasure of unprinted image data is prevented, and the printed image data can be easily erased.

<Fifth Embodiment>

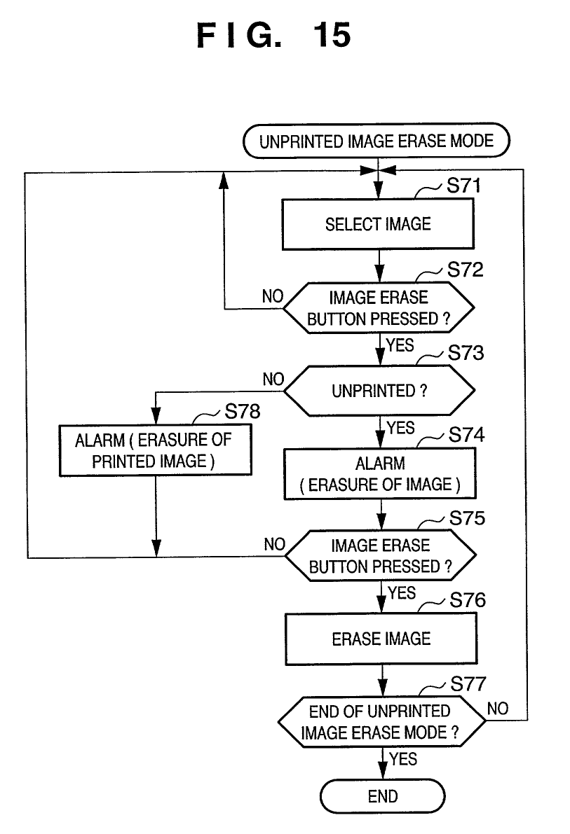

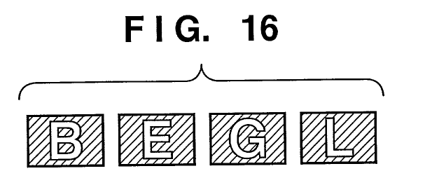

The fifth embodiment of the present invention will be described with reference to FIGS. 15 and 16. FIG. 15 is a flow chart showing the operation sequence in an unprinted image erase mode of a camera with a printer according to the fifth embodiment of the present invention. FIG. 16 is a view illustrating image data erasure in the unprinted image simultaneous erase mode. Note that the camera with a printer according to this embodiment has the same arrangement as in the third embodiment, and a detailed description thereof will be omitted. The same reference numerals as in the third embodiment denote the same parts in the fifth embodiment.

In the fifth embodiment, the camera with a printer has an unprinted image erase mode for erasing unprinted image data. The fifth embodiment further has an unprinted image simultaneous erase mode for simultaneously selecting and erasing unprinted image data.

When the user sets the unprinted image erase mode with a mode setting unit 6, the user operates a next-image button 112 and previous-image button 113 to select image data to be erased while displaying the image data on a display panel 110 in step S71, as shown in FIG. 15. The flow advances to step S72 to determine whether an image erase button 116 is operated. If NO in step S72 (any other button is operated), the flow returns to step S71.

If YES in step S72, the flow advances to step S73 to determine on the basis of the discrimination result of a printing discrimination unit 7 whether the selected image data is unprinted image data. If YES in step S73, the flow advances to step S74 to alarm erasure of the selected image data by an alarm unit 3. More specifically, an alarm for erasure of image data is displayed on the display panel 110. This alarm may be displayed as a phrase, such as “image erasure OK?”, or may be displayed with any symbol. In the fifth embodiment, the alarm is displayed on the display panel 110. However, a sound alarm may be used.

The flow then advances to step S75 to determine whether the image erase button 116 is operated again. If NO in step S75 (e.g., another button is operated), the flow returns to step S71. When it is determined that the image erase button 116 is operated, the flow advances to step S76 to erase the selected image data. The flow then advances to step S77 to determine whether the unprinted image erase mode is ended. If NO in step S77, the flow returns to step S71; otherwise, this processing is ended.

When it is determined in step S73 that the selected image data is printed image data, the flow advances to step S78 to alarm that the selected image is the printed image data by the alarm unit 3. More specifically, this alarm is displayed on the display panel 110. This may be displayed in a phrase, “Printed image!!”, or using any symbol. A sound alarm may be used. The flow then returns to step S71.

The camera with a printer in fifth embodiment can be set to the unprinted-image simultaneous erase mode for simultaneously erasing unprinted image data out of the image data stored in a memory 8.

An erasure operation in the unprinted image simultaneous erase mode will be described with reference to FIGS. 14A and 16.

For example, as shown in FIG. 14A, assume that 12 image data A to L (the number of image data may be arbitrary) are stored in the memory 8. When the user sets the unprinted image simultaneous erase mode with the mode setting unit 6 and operates the image erase button 116, a camera microcomputer 1 alarms by the alarm unit 3 that all the unprinted image data will be erased. More specifically, an alarm for erasing all the unprinted image data is displayed on the display panel 110. This alarm may be made in a phrase, e.g., “All the unprinted image data will be erased OK?”, or by any symbol. Alternatively, a sound may be used instead of displaying the alarm on the display panel 110.

After the alarm for erasure of all the unprinted image data, when the image erase button 116 is operated again, all the unprinted image data are erased, and only printed image data (B, E, G, and L) are left in the memory 8, as shown in FIG. 16.

As described above, according to the fifth embodiment, only the unprinted image data can be selectively erased. Further, it is possible to simultaneously select and erase all the unprinted image data.

<Sixth Embodiment>

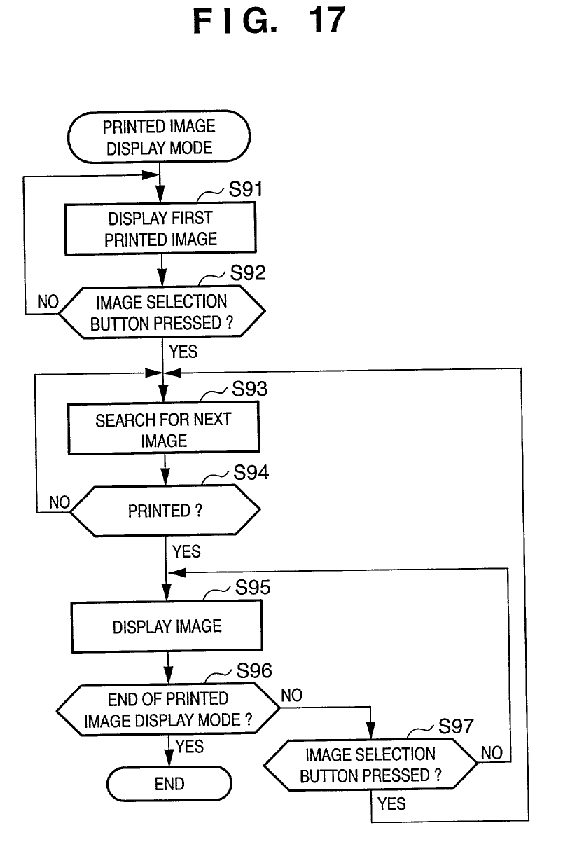

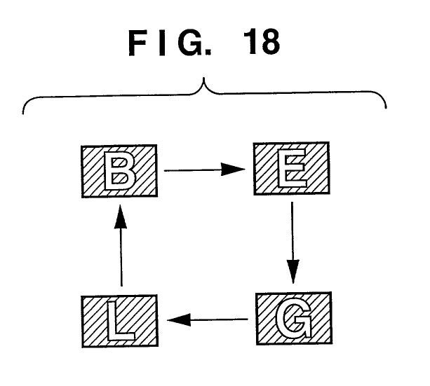

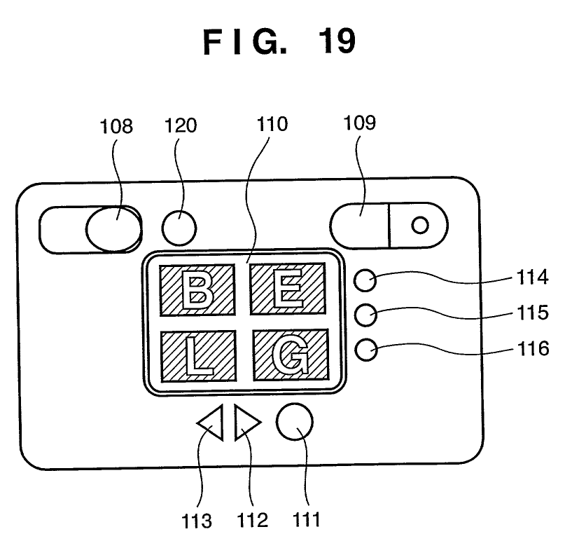

The sixth embodiment of the present invention will be described with reference to FIGS. 17 to 19. FIG. 17 is a flow chart showing the operation sequence in a printed image display mode of a camera with a printer according to the sixth embodiment of the present invention. FIG. 18 is a view showing a display example of printed images in the printed image display mode, and FIG. 19 is a view showing a display example of printed images in a printed image list display mode.

The camera with a printer according to this embodiment has the same arrangement as in the third embodiment, and a detailed description thereof will be omitted. The same reference numerals as in the third embodiment denote the same parts in the sixth embodiment.

In the sixth embodiment, the camera with a printer has a printed image display mode for displaying only printed image data. The camera with a printer in the sixth embodiment further has a printed image list display mode for displaying a list of only printed image data.

In the sixth embodiment, image data A to L are stored in a memory 8 as in FIG. 14A. The printed image data and unprinted image data are defined in the same manner as in the fourth embodiment.

When the user sets a printed image display mode with a mode setting unit 6 and operates a next-image button 112, the printed image data in the memory 8 are sequentially displayed on a display panel 110 as indicated by arrows in FIG. 18 every time the next-image button 112 is operated.

More specifically, when the printed image display mode is set with the mode selection unit 6, the first printed image data is displayed on the display panel 110 in step S91, as shown in FIG. 17. The first printed image may be defined as the latest photographed image or oldest photographed image among the printed images. Alternatively, the first printed image may be an arbitrary printed image.

The flow then advances to step S92 to determine whether the next-image button 112 or a previous-image button 113 (to be referred to as image selection buttons hereinafter) is operated. If NO in step S92, the flow returns to step S91 to keep displaying the first printed image on the display panel 110. However, if the image selection button is operated, the flow advances to step S93 to search for the next image data from the image data stored in the memory 8.

When the next image data is searched, the flow advances to step S94 to determine whether the next image data searched is printed image data on the basis of the discrimination result of a printing discrimination unit 7. If NO in step S94, the flow returns to step S93 to search for the next image; otherwise, the flow advances to step S95 to display the searched image data on the display panel 110.

The flow then advances to step S96 to determine whether the printed image display mode is ended. If NO in step S96, the flow advances to step S97 to determine whether the image selection button is operated. If NO in step S97, the flow returns to step S95 to keep displaying the same image on the display panel 110. Whereas, when it is determined that the image selection button is operated, the flow returns to step S93 to search for the next image data from the image data stored in the memory 8.

When it is determined in step S96 that the printed image display mode is ended, this processing is ended.

When the printed image list display mode for displaying the list of only the printed image data is set with the mode setting unit 6, the list of the printed image data is displayed on the display panel 110, as shown in FIG. 19. The example in FIG. 19 corresponds to the case in which the image data A to L are stored in the memory 8 as in FIG. 14A. Since the number of image data displayed per screen (e.g., 4 to 9) is determined in advance, the next-image button 112 is operated to scroll the screen to display the remaining printed image data if the number of printed image data is larger than the number of image data displayed per screen.

As described above, according to the sixth embodiment, only the printed image data can be easily browsed from the stored image data.

<Seventh Embodiment>

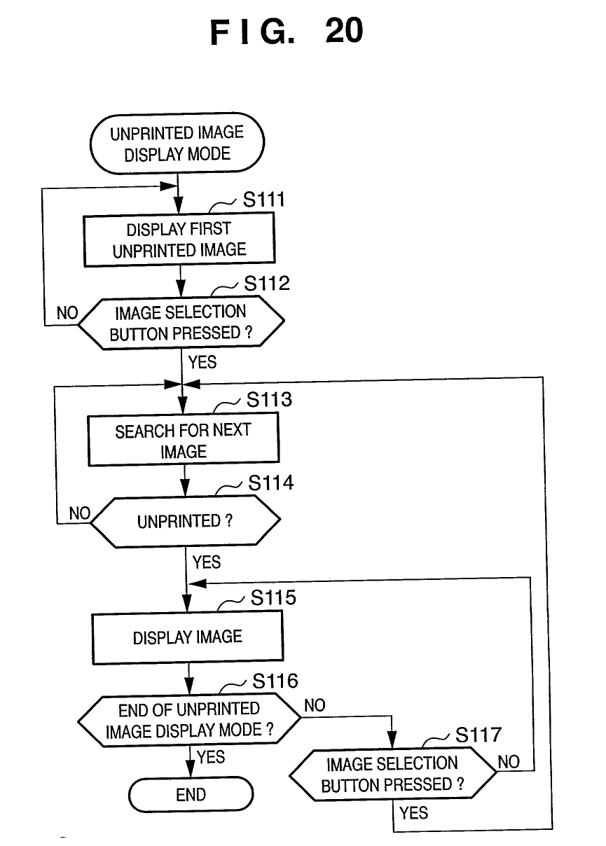

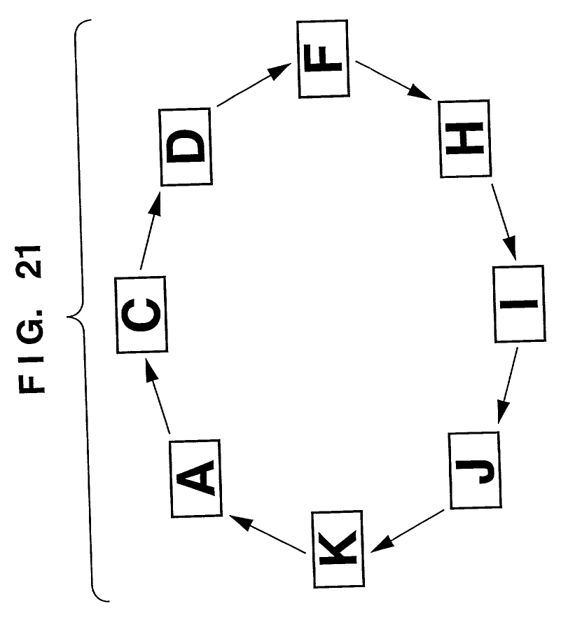

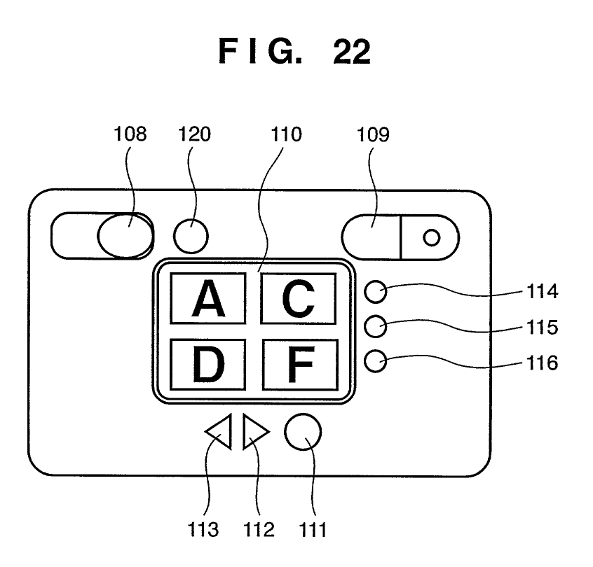

The seventh embodiment of the present invention will be described with reference to FIGS. 20 to 22. FIG. 20 is a flow chart showing the operation sequence in an unprinted image display mode of a camera with a printer according to the seventh embodiment of the present invention. FIG. 21 is a view showing a display example of unprinted images in the unprinted image display mode, and FIG. 22 is a view showing a display example of the unprinted images in an unprinted image list display mode.

The camera with a printer according to this embodiment has the same arrangement as in the third embodiment, and a detailed description thereof will be omitted. The same reference numerals as in the third embodiment denote the same parts in the seventh embodiment.

In the seventh embodiment, the camera with a printer has an unprinted image display mode for displaying only unprinted image data. The camera with a printer in the seventh embodiment further has an unprinted image list display mode for displaying a list of only unprinted image data.

In the seventh embodiment, image data A to L are stored in a memory 8 as in FIG. 14A. The unprinted image data and printed image data are defined in the same manner as in the fourth embodiment.

When the user sets an unprinted image display mode with a mode setting unit 6 and operates a next-image button 112, the unprinted image data in the memory 8 are sequentially displayed on a display panel 110 as indicated by arrows in FIG. 21 every time the next-image button 112 is operated.

More specifically, when the unprinted image display mode is set with the mode selection unit 6, the first unprinted image data is displayed on the display panel 110 in step S111, as shown in FIG. 20. The first unprinted image may be defined as the latest photographed image or oldest photographed image among the unprinted images. Alternatively, the first unprinted image may be an arbitrary unprinted image.

The flow then advances to step S112 to determine whether the next-image button 112 or a previous-image button 113 (to be referred to as image selection buttons hereinafter) is operated. If NO in step S112, the flow returns to step S111 to keep displaying the first unprinted image on the display panel 110. However, if the image selection button is operated, the flow advances to step S113 to search for the next image data from the image data stored in the memory 8.

When the next image data is searched, the flow advances to step S114 to determine whether the next image data searched is unprinted image data on the basis of the discrimination result of a printing discrimination unit 7. If NO in step S114, the flow returns to step S113 to search for the next image; otherwise, the flow advances to step S115 to display the searched image data on the display panel 110.

The flow then advances to step S116 to determine whether the unprinted image display mode is ended. If NO in step S116, the flow advances to step S117 to determine whether the image selection button is operated. If NO in step S117, the flow returns to step S115 to keep displaying the same image on the display panel 110. Whereas, when it is determined that the image selection button is operated, the flow returns to step S113 to search for the next image data from the image data stored in the memory 8.

It is determined in step S116 that the unprinted image display mode is ended, this processing is ended.

When the unprinted image list display mode for displaying the list of only the unprinted image data is set with the mode setting unit 6, the list of the printed image data is displayed on the display panel 110, as shown in FIG. 22. The example in FIG. 22 corresponds to the case in which the image data A to L are stored in the memory 8 as in FIG. 14A. Since the number of image data displayed per screen (e.g., 4 to 9) is determined in advance, the next-image button 112 is operated to scroll the screen to display the remaining unprinted image data if the number of unprinted image data is larger than the number of image data displayed per screen.

As described above, according to the seventh embodiment, only the unprinted image data can be easily browsed from the stored image data.

Each of the first to seven embodiments has exemplified a camera with a printer. However, the present invention is not limited to a camera, but may be applied to an image sensing device, such as scanner, for obtaining image data by a photoelectric conversion element.

<Other Embodiment>

Further, the object of the present invention can also be achieved by providing a storage medium storing program codes for performing the aforesaid processes to an image sensing apparatus with a printer, reading the program codes, by a CPU or MPU of the image sensing apparatus with a printer, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by an image sensing apparatus with a printer, the present invention includes a case where an OS (operating system) or the like working on the image sensing apparatus with a printer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flow charts in FIGS. 4, 5, 8, 12, 13, 15, 17, or 20, or combinations thereof described in the embodiments.

Further, in each embodiment described above, the displayed printing date is given as the latest printing date. However, the present invention is applicable even if other dates, such as dates when printing has been performed in the past are used.

In each embodiment described above, a printer is formed integrally with an image sensing apparatus. The present invention, however, is applicable to an image sensing apparatus connectable to a printer which is formed independently of the image sensing apparatus.

Each embodiment and its constituent elements may be combined, as needed.

The present invention is not limited to the above embodiments and various changes and modifications can be made within the spirit and scope of the present invention. Therefore to apprise the public of the scope of the present invention, the following claims are made.

What is claimed is:

1. An image sensing apparatus usable in combination with a printer for printing a sensed image, comprising:
(A) a recording device that records a first state representing that a sensed image has been printed; and
(B) a changing device that changes the first state to a second state representing that the sensed image has not been printed.

2. The apparatus according to claim 1, wherein the printer is formed integrally with the image sensing apparatus.

3. The apparatus according to claim 2, further comprising a display device that displays the sensed image so as to be able to identify that the displayed image has been printed in accordance with the first state recorded by said recording device.

4. The apparatus according to claim 3, further comprising a designation device that designates to cause said display device not to identify that the displayed image has been printed.

5. The apparatus according to claim 3, wherein said recording device records at least one of a printed count and printing date, and said display device displays at least one of the printed count and printing date recorded by said recording device.

6. An image sensing apparatus usable in combination with a printer for printing a sensed image, comprising:
(A) a recording device that records at least one of a printed count and printing date of a sensed image; and
(B) a display device that displays at least one of the printed count and printing date of a displayed image in accordance with a content recorded by said recording device.

7. The apparatus according to claim 6, wherein the printer is formed integrally with the image sensing apparatus.

8. An image sensing apparatus usable in combination with a printer for printing a sensed image, comprising:
(A) a recording device that records sensed image data;
(B) a designation device that designates erasure of image data recorded in said recording device; and
(C) an alarm device that generates a predetermined alarm in accordance with whether or not the image data designated for erasure by said designation device has been printed.

9. The apparatus according to claim 8, wherein the printer is formed integrally with the image sensing apparatus.

10. An image sensing apparatus usable in combination with a printer for printing a sensed image, comprising:
(A) a recording device that records sensed image data; and
(B) an erase device that simultaneously erases the recorded image data which has been printed in said recording device without erasing the recorded image data which has not been printed.

11. The apparatus according to claim 10, wherein the printer is formed integrally with the image sensing apparatus.

12. An image sensing apparatus usable in combination with a printer for printing a sensed image, comprising:
(A) a recording device that records sensed image data; and
(B) an erase device that simultaneously erases the recorded image data which has not been printed without erasing the sensed image data which has been printed in said recording device.

13. The apparatus according to claim 12, wherein the printer is formed integrally with the image sensing apparatus.

14. An image sensing apparatus usable in combination with a printer for printing a sensed image, comprising:
(A) a recording device that records sensed image data;
(B) a display device that displays the sensed image data which has been recorded in said recording device; and
(C) a designation device that causes said display device to display the sensed image data which has been printed without causing said display device to display the sensed image data which has not been printed.

15. The apparatus according to claim 14, wherein the printer is formed integrally with the image sensing apparatus.

16. An image sensing apparatus usable in combination with a printer for printing a sensed image, comprising:
(A) a recording device that records sensed image data;
(B) a display device that displays the sensed image data which has been recorded in said recording device; and
(C) a designation device that causes said display device to display the sensed image data which has not been printed without causing said display device to display the sensed image data which has been printed.

17. The apparatus according to claim 16, wherein the printer is formed integrally with the image sensing apparatus.

18. A method for controlling an image sensing apparatus usable in combination with a printer for printing a sensed image, comprising:
(A) a recording step of recording a first state representing that a sensed image has been printed; and
(B) a changing step of changing the first state to a second state representing that the sensed image has not been printed.

19. The method according to claim 18, further comprising a display step of displaying the sensed image so as to be able to identify that the displayed image has been printed in accordance with the first state recorded in said recording step.

20. The method according to claim 19, further comprising a designation step of designating to cause, in said display step, not to identify that the displayed image has been printed.

21. The method according to claim 19, wherein, in said recording step, at least one of a printed count and printing date is recorded, and at least one of the printed count and printing date recorded in said recording step is displayed in said display step.

22. A method for controlling an image sensing apparatus usable in combination with a printer for printing a sensed image, comprising:
(A) a recording step of recording at least one of a printed count and printing date of a sensed image; and
(B) a display step of displaying at least one of the printed count and printing date of a displayed image in accordance with a content recorded in said recording step.

23. A method for controlling an image sensing apparatus usable in combination with a printer for printing a sensed image, comprising:
(A) a recording step of recording sensed image data;
(B) a designation step of designating erasure of image data recorded in said recording step; and
(C) an alarming step of generating a predetermined alarm in accordance with whether or not the image data designated for erasure in said designation step has been printed.

24. A method for controlling an image sensing apparatus usable in combination with a printer for printing a sensed image, comprising:
(A) a recording step of recording sensed image data; and
(B) an erasing step of simultaneously erasing the recorded image data which has been printed in said recording step without erasing the recorded image data which has not been printed.

25. A method for controlling an image sensing apparatus usable in combination with a printer for printing a sensed image, comprising:
(A) a recording step of recording sensed image data; and
(B) an erasing step of simultaneously erasing the recorded image data which has not been printed without erasing the sensed image data which has been printed in said recording step.

26. A method for controlling an image sensing apparatus usable in combination with a printer for printing a sensed image, comprising:
(A) a recording step of recording sensed image data;
(B) a display step of displaying the sensed image data which has been recorded in said recording step; and
(C) a designation step of causing, in said display step, to display the sensed image data which has been printed without causing, in said display step, to display the sensed image data which has not printed.

27. A method for controlling an image sensing apparatus usable in combination with a printer for printing a sensed image, comprising:
(A) a recording step of recording sensed image data;
(B) a display step of displaying the sensed image data which has been recorded in said recording step; and
(C) a designation step of causing, in said display step, to display the sensed image data which has not been printed without causing, in said display step, to display the sensed image data which has been printed.

28. A computer program product comprising a computer usable medium having computer readable program code means embodied in said medium for a method for controlling an image sensing apparatus usable in combination with a printer for printing a sensed image said product including:
first computer readable program code means for recording a first state representing that a sensed image has been printed; and
second computer readable program code means for changing the first state to a second state representing that the sensed image has not been printed.

29. The computer program product according to claim 28, further comprising third computer readable program code means for displaying the sensed image so as to be able to identify that the displayed image has been printed in accordance with the first state recorded by said first computer readable program code means.

30. The computer program product according to claim 29, further comprising a fourth computer readable program code means for designating to cause said third computer readable program code means not to identify that the displayed image has been printed.

31. The computer program product according to claim 29, wherein said third computer readable program code means records at least one of a printed count and printing date, and third computer readable program code means displays at least one of the printed count and printing date recorded in said first computer readable program code means.

32. A computer program product comprising a computer usable medium having computer readable program code means embodied in said medium for a method for controlling an image sensing apparatus usable in combination with a printer for printing a sensed image said product including:
first computer readable program code means for recording at least one of a printed count and printing date of a sensed image; and
second computer readable program code means for displaying at least one of the printed count and printing date of a displayed image in accordance with a content recorded by said first computer readable program code means.

33. A computer program product comprising a computer usable medium having computer readable program code means embodied in said medium for a method for controlling an image sensing apparatus usable in combination with a printer for printing a sensed image said product including:
first computer readable program code means for recording sensed image data;
second computer readable program code means for designating erasure of image data recorded by said first computer readable program code means; and
third computer readable program code means for generating a predetermined alarm in accordance with whether or not the image data designated for erasure by said second computer readable program code means has been printed.

34. A computer program product comprising a computer usable medium having computer readable program code means embodied in said medium for a method for controlling an image sensing apparatus usable in combination with a printer for printing a sensed image said product including:
first computer readable program code means for recording sensed image data; and
second computer readable program code means for simultaneously erasing the recorded image data which has been printed by said first computer readable program code means without erasing the recorded image data which has not been printed.

35. A computer program product comprising a computer usable medium having computer readable program code means embodied in said medium for a method for controlling an image sensing apparatus usable in combination with a printer for printing a sensed image said product including:
first computer readable program code means for recording sensed image data; and
second computer readable program code means for simultaneously erasing the recorded image data which has not been printed without erasing the sensed image data which has been printed by said first computer readable program code means.

36. A computer program product comprising a computer usable medium having computer readable program code means embodied in said medium for a method for controlling an image sensing apparatus usable in combination with a printer for printing a sensed image said product including:
first computer readable program code means for recording sensed image data;
second computer readable program code means for displaying the sensed image data which has been recorded by said first computer readable program code means; and
third computer readable program code means for causing said second computer readable program code means to display the sensed image data which has been printed without causing said second computer readable program code means to display the sensed image data which has not been printed.

37. A computer program product comprising a computer usable medium having computer readable program code means embodied in said medium for a method for controlling an image sensing apparatus usable in combination with a printer for printing a sensed image said product including:
first computer readable program code means for recording sensed image data;
second computer readable program code means for displaying the sensed image data which has been recorded by said first computer readable program code means; and
third computer readable program code means for causing said second computer readable program code means to display the sensed image data which has not been printed without causing said second computer readable program code means to display the sensed image data which has been printed.
